(19) United States
(12) Patent Application Publication
(10) Pub. No.: US 2005/0182928 A1
(43) Pub. Date: Aug. 18, 2005

(54) System and method for secure HTML links

(76) Inventors: Chandar Kamalanathan, Austin, TX (US); Fabiano DeSouza, Austin, TX (US); Ching-Lung Tjiong, Austin, TX (US); Reva Tolliver, Austin, TX (US)

Correspondence Address: HAMILTON & TERRILE, LLP, P.O. BOX 203518, AUSTIN, TX, 78720, US

(21) Appl. No.: 10/777,600

(22) Filed: Feb. 12, 2004

(51) Int. Cl. H04L 9/00

(52) U.S. Cl. 713/164

(57) ABSTRACT

HTML links published in an HTML framework, such as a web page, select execution of restricted functions requiring a distinct user confirmation. Encrypted protocols associate with the HTML links are decrypted by a web browser retrieving the HTML framework for execution of the restricted function without the distinct user confirmation. For instance, binaries and scripts that are restricted from running upon selection through a browser until a distinct user confirmation is made instead execute automatically with selection of the HTML link upon validation of the associated decrypted protocol. Encrypted protocols are created by content author with a private key for security and are decrypted with a public key at an information handling system that retrieves the content to validate the content and execute restricted functions without further user permission.

### BACKGROUND OF THE INVENTION

1. Field of the Invention

The present invention relates in general to the field of information handling system network communication, and more particularly to a system and method for secure HTML links.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems have impacted businesses and individuals by, for instance, increasing work productivity and increasing the availability of information for access and use. One prominent example of the improvement provided by information handling systems is the networking of systems through the Internet and World Wide Web environments. The World Wide Web supports the display of interactive graphics through standardized formats, such as Hyper Text Transfer Protocol (“HTTP”) and Hyper Text Mark-up Language (“HTML”). HTML makes the navigation by a user through information posted in Web pages relatively simple by presenting HTML links to a user through a Web browser. The user selects an HTML link by pointing and clicking with a mouse to go to another Web page. In some instances, HTML links presented on a Web page command execution of binaries or scripts on the information handling system that displays the Web page. Typically, after the user clicks on the HTML link, an executable program associated with the binary or script downloads to the information handling system and automatically runs.

One difficulty that has arisen with the increased use of the World Wide Web is the spread of malicious programs, such as viruses, worms and spyware. Users sometimes inadvertently introduce malicious programs by the execution of binaries or scripts from an HTML link displayed on a Web page. In an attempt to avoid infection by malicious programs, Web browsers typically warn users about the risk of introduction of malicious programs and restrict execution of certain functions by users. For instance, a restricted functions that typically require a distinct user confirmation before allowing a user's click on an HTML link to take effect are links having binaries or scripts that download and execute programs. For instance, the EXPLORER browser available from MICROSOFT activates a confirmation or warning window that requires the user to confirm a selection of a link before performing execution of the link, such as asking whether to save or open the downloaded program. The warning window states that the execution of the HTML link may allow a non-secure program to execute and asks if the user wishes to execute the link anyway. Although such browser warnings are effective at warning users of the risks involved, they provide little other information for the user to reference in making the decision of whether or not to execute the binary or script. This often causes a user to hesitate and thus slows the user's progress and, additionally, leads to mistrust by the user of downloaded information.

### SUMMARY OF THE INVENTION

Therefore a need has arisen for a system and method which executes restricted browser functions, such as binary or script HTML links, securely on an initial user selection.

In accordance with the present invention, a system and method are provided which substantially reduce the disadvantages and problems associated with previous methods and systems for executing restricted functions, such as binary or script HTML links. Encrypted protocols associated with an HTML link having a restricted function are decrypted at an information handling system to authorize execution of the HTML link by overriding the restricted function. Restricted functions requested through an encrypted protocol are thus securely executed without requiring presentation to the user of a function confirmation.

More specifically, a protocol encryption tool applies a private key to encrypt defined protocols, each protocol associated with a restricted function, and associate the encrypted protocols with HTML links. An HTML editor loads the encrypted protocols and HTML links into an HTML framework, such as a web page, for publication on a network accessible to information handling systems, such as browser-enabled information handling systems interfaced with the World Wide Web. A browser retrieves the HTML framework and an associated protocol filter preprocesses the encrypted protocols within the HTML framework to allow a protocol decryption engine to decrypt the encrypted protocols with a public key substantially upon retrieval of the HTML framework by the browser. User selection of a decrypted protocol overrides the browser restricted function confirmation requirement to allow browser execution of the restricted function securely and without additional user confirmation.

The present invention provides a number of important technical advantages. One example of an important technical advantage is that a browser executes restricted functions, such as binaries and scripts, without requiring a function confirmation by a user and thus reduces the risk of confusion and mistrust by the user. Automatic execution of restricted functions selected by a user upon decryption of a protocol reduces the hassle to the user associated with navigation through trusted web sites. For instance, an information handling system manufacturer performs automated support and diagnostics through secure HTML links so that users are presented with minimal complexity and inconvenience.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for secure HTML links; and

FIG. 2 depicts a flow diagram of a process for secure HTML links.

### DETAILED DESCRIPTION

Restricted browser functions are executed by an information handling system upon initial selection of an HTML link and without distinct confirmation if an encrypted protocol associated with the HTML link decrypts at the information handling system to validate the security of the HTML link. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

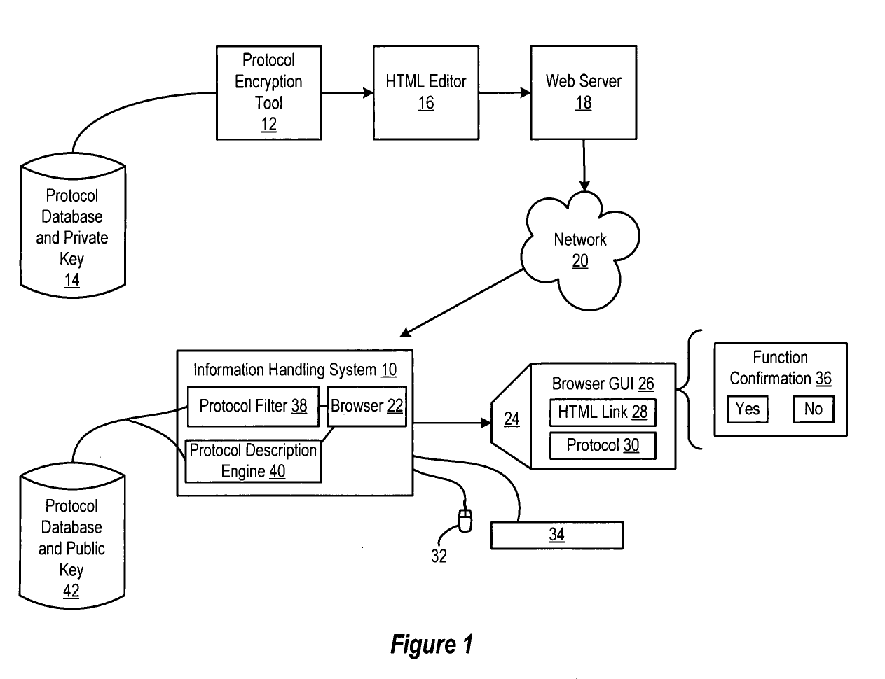

Referring now to FIG. 1, a block diagram depicts a system for secure HTML links that execute restricted functions without requiring distinct user confirmation at an information handling system 10. A protocol encryption tool 12 encrypts protocols with a private key according to definitions of a protocol and private key database 14. Each protocol is an element that is attachable to HTML links and has a specific function for execution at an information handling system browser. For instance, an “execute” protocol will execute binaries and an “executewsh” protocol will execute scripts. Other types of protocols defined by protocol and private key database 14 may execute specifically defined functions, such as support or maintenance functions defined by an information handling system manufacture as a browser plug-in, or may command a save of a binary or script to information handling system 10. Protocol encryption tool 12 provides the encrypted protocols to an HTML editor 16 for creation of an HTML page with the link to execute the associated functions. The HTML page is published by a web server 18 for access by information handling systems through a network 20, such as the Internet.

Information handling system 10 supports a browser 22 that retrieves web pages from web server 18, including web pages having an HTML framework with encrypted protocols. A display 24 interfaced with information handling system 10 presents the retrieved web page in a browser graphical user interface 26, including the HTML link 28 and associated encrypted protocol 30. A user selects HTML link 28 and its associated encrypted protocol 30 through a pointing “mouse” device 32 or keyboard 34 that are interfaced with information handling system 10. User selection of an HTML link associated with a restricted function and lacking an encrypted protocol, such as an unencrypted HTML link for execution of a binary or script, results in presentation of a function confirmation window 36. The user confirms the execution of the unencrypted link by selecting “yes” and cancels the execution by selecting “no.” Alternatively, the function confirmation window 36 may present “execute” versus “save” options, as is presented by MICROSOFT EXPLORER.

A protocol filter 38 preprocess a retrieved web page substantially simultaneous with retrieval of the web page to identify encrypted protocols before actual navigation of the web page by user inputs through browser 22. Encrypted links are provided to protocol decryption engine 40 which decrypts the links by reference to a protocol and public key database 42. Decrypted strings selected by a user are processed by protocol definitions from database 42 with protocol engine 40 overriding the function confirmation required by browser 22. Decrypted strings that are not successfully decrypted are not executed and an appropriate warning of an invalid HTML link is provided to the user through browser GUI 36. For example, HTML link 28 and protocol 30 have the format:
[html file]?protocol=[protocol name and parameters]
   so that protocol engine 40 looks-up the protocol name and parameters to execute the desired restricted function. For instance, the HTML link 28 and protocol 30 having the format:
home.htm?protocol=executewsh;xxxxxxx
   results in the execution of the script that decrypts from “xxxxxxx”. The execution of the script is authorized by protocol engine 40 without a distinct confirmation by a user otherwise required for execution of a script from an HTML link. In one alternative embodiment, protocol engine 40 validates successfully decrypted protocols by altering function confirmation 36 so that the user is still required to confirm the restricted function but is provided with an altered function confirmation 36 that informs the user of the validation of the HTML link.

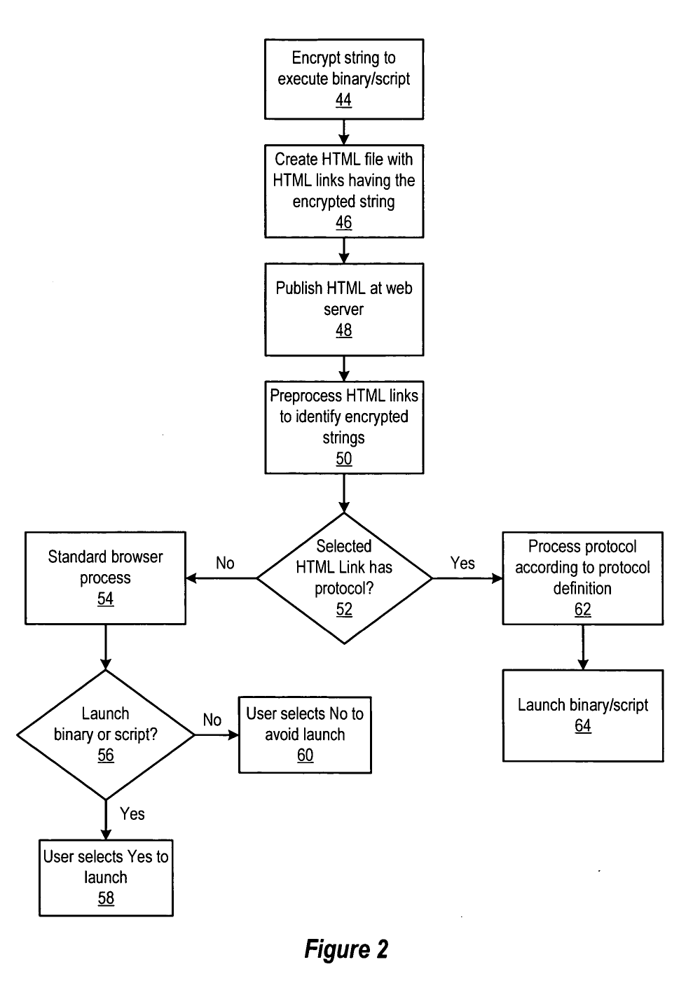

Referring now to FIG. 2, a flow diagram depicts a process for secure HTML links that execute restricted functions without requiring distinct user confirmation at an information handling system. The process begins at step 44 with encryption of a string to execute a binary or script. At step 46, an HTML file is created with the HTML links having the encrypted string and, at step 48, the HTML file is published at a web server. At step 50, a browser retrieves the HTML file and preprocesses the HTML links during retrieval to identify encrypted strings for decryption. At step 52, a user selects a HTML link and a determination is made of whether the selected link has an associated encrypted protocol. If not, the process continues to step 54 for standard browser processing in which the user is presented at step 56 with a confirmation to launch a binary or script. Confirmation by the user launches the script or binary while non-confirmation voids the selected HTML from execution of the binary or script. If at step 52 an encrypted protocol is selected, the process continues to step 62 for processing of the protocol according to the protocol definition. For instance, at step 64 a binary or script associated with the protocol is launched without confirmation by the user or the information handling system.

Although the present invention has been described in detail, it should be understood that various changes, substitutions and alterations can be made hereto without departing from the spirit and scope of the invention as defined by the appended claims.

1. A system for secure HTML links, the system comprising:
a protocol encryption tool operable to associate encrypted protocols with HTML links, each protocol associated with a restricted browser function;
an editor operable to publish an HTML link and associated encrypted protocol in a web page;
a browser operable to display the web page and HTML link, the browser having one or more restricted functions, each restricted function requiring at least selection of an HTML link and a function confirmation before the browser executes the function; and
a protocol decryption engine interfaced with the browser, the protocol decryption engine operable to decrypt the encrypted protocol associated with the HTML link and authorize execution of the associated restricted browser function without the function confirmation.

2. The system of claim 1 wherein the restricted browser function comprises a command to execute a binary.

3. The system of claim 1 wherein the restricted browser function comprises a command to save a binary.

4. The system of claim 1 wherein the restricted browser function comprises a command to execute a script.

5. The system of claim 1 wherein the restricted browser function comprises a command to save a script.

6. The system of claim 1 further comprising a protocol filter associated with the browser and operable to preprocess plural encrypted protocols upon retrieval of the web page by the browser.

7. The system of claim 1 wherein the protocol encryption tool comprises a private key for encryption of protocols.

8. The system of claim 7 wherein the protocol decryption engine comprises a public key.

9. A method for secure HTML links, the method comprising:
encrypting a protocol associated with a restricted browser function;
publishing the encrypted protocol in an HTML framework to associate with an HTML link that executes the restricted browser function;
displaying the HTML framework through a browser, the browser restricting execution of restricted functions by requiring a distinct confirmation before execution of the restricted function;
decrypting the encrypted protocol at the browser; and
authorizing execution of the restricted function without the distinct confirmation.

10. The method of claim 9 wherein encrypting a protocol further comprises encrypting the protocol with a private key.

11. The method of claim 10 wherein decrypting the protocol further comprises decrypting the protocol with a public key.

12. The method of claim 11 wherein authorizing execution of the restricted function further comprises authorizing execution of a binary by the browser.

13. The method of claim 11 wherein authorizing execution of the restricted function further comprises authorizing saving of a binary by the browser.

14. The method of claim 11 wherein authorizing execution of the restricted function further comprises authorizing execution of a script by the browser.

15. The method of claim 11 wherein authorizing execution of the restricted function further comprises authorizing saving of a script by the browser.

16. The method of claim 11 further comprising preprocessing of plural encrypted protocols substantially upon loading of the HTML framework to the browser.

17. The method of claim 11 wherein the distinct confirmation comprises a window displayed upon user selection of an HTML link associated with a restricted function, the window requiring at least one addition input by the user before execution of the restricted function.

18. An information handling system comprising:
a browser operable to retrieve and display a HTML link associated with a restricted function, the browser requiring a distinct confirmation of a selection of the HTML link before execution of the restricted function;
an encrypted protocol associated with the HTML link;
a protocol decryption engine interfaced with the browser and operable to override the distinct confirmation requirement upon decryption and validation of the encrypted protocol.

19. The information handling system of claim 18 wherein the browser is further operable to retrieve a web page having plural encrypted protocols, the information handling system further comprising a protocol filter interfaced with the browser and operable to identify the plural encrypted protocols for decrypting by the protocol decryption engine.

20. The information handling system of claim 19 further comprising a protocol database interfaced with the protocol decryption engine and having a table of protocols and associated restricted functions.
